(19) United States
(12) Patent Application Publication
(10) Pub. No.: US 2016/0253816 A1
(43) Pub. Date: Sep. 1, 2016

(54) Method of Carrying Out Land Based Projects Using Aerial Imagery Programs

(71) Applicant: Andrew Niemczyk, Hazel Park, MI (US)

(72) Inventor: Andrew Niemczyk, Hazel Park, MI (US)

(21) Appl. No.: 14/631,996

(22) Filed: Feb. 26, 2015

(51) Int. Cl. G06T 7/00; G06T 11/60; G06T 15/08

(52) U.S. Cl. CPC G06T 7/0081; G06T 15/08; G06T 11/60; G06T 2207/10032; G06T 2207/30184; G06T 2207/30188

(57) ABSTRACT

Additional capabilities added to an aerial image programs are disclosed including enabling the user to generate a series of markers to an aerial image at a user selected spacing, and to enable calculations of an aerial image and allow the user to enter data to be used in these calculations, for facilitating projects such as paving, decking, roofing and fertilizing in user delineated subregions of an aerial image.

### CROSS REFERENCE TO RELATED APPLCATIONS

This application claims the benefit of U.S. provisional application no. 61/945,310 filed on Feb. 27, 2014.

### BACKGROUND OF THE INVENTION

This application concerns facilitating planning of various projects carried out on land areas, such as paving, roofing, building decks and fertilizing.

Such projects often involve laying out the project on a drawing so as to determine the material requirements of the project, such as the quantity of material needed the number of components, etc.

Common examples are projects for paving particular areas, which require that the quantity of paving material must to be determined, or for building a fence in which the number of posts must be determined.

The present inventor has developed a way to enhance the percolation of surface water into the ground, involving drilling a series of hole patterns into the ground along a path and installing tubular passive pumps into the drilled holes.

See U.S. Pat. No. 8,562,250 issued to the present inventor for further information.

In carrying out such projects a layout drawing of the array of holes must be prepared for the purpose of determining the number and location of holes to be drilled into the ground and counting the number of passive pumps needed in order to determine how many pumps are needed to carry out the project.

Such a prior art layout drawing involving that invention is depicted in FIG. 1 in which tubular pumps arrays 10A, 10B, 10C, 10D, 10E and 10F are shown installed in holes drilled into the ground. The arrays 10E-10F are typically located accurately with respect to existing features such as trees 12, paved areas 14 and buildings 16.

The arrays are drawn in their proper location and the number of tubular pumps necessary are totaled up by counting the number of pumps on the drawing.

There are existing aerial image programs, the most well known being Google Earth and Google Earth Pro, (trademarks) provided by Google, Inc., which enable images of selected areas of the earth's surface to be displayed on a monitor, with points along a line electronically able to be marked by a user to define the boundary of a subregion of interest to the user lying within the image of a larger area.

While the total length of a boundary line can be generated by existing programs, no other calculation capability of such programs is thought to have heretofore been provided, such as to aid in calculations completing out such projects.

It would be of help to persons planning such land area based projects if such calculations could be carried out by the programs in order to determine the requirements of such a project.

It is the object of the present invention to enable use of such aerial image programs to plan a project to be carried out within the land area able to be imaged by a user.

### SUMMARY OF THE INVENTION

The above recited object and other objects which will be appreciated by those skilled in the art are achieved by adding certain capabilities to Google Earth and other similar land aerial imaging programs which will assist a user in planning a project. One capability is to be able to create display of a line of markers on the program image of an area with the earth's surface at any user selected spacing along a line delineating a selected subregion of interest or elsewhere within a selected subregion so as to quickly indicate to the user the total number of components corresponding to the markers such as fence posts. The program also can have the capability of totaling up the number of markers (and fence posts) spaced along the line. The markers could correspond to other elements such as drilled hole patterns and pumps for the project described above.

Another added capability of the present invention is the ability to calculate the user of any subregion delineated by the use in selected measurement units as for carrying out a paving project, and the total volume of material for a paving area of a user selected thickness in the case of continuous paving. This enables a user to quickly determine the total volume of materials such as poured concrete, asphalt or the like needed to carry out the project. Also, the number of paving bricks or stones for a non continuous pavement needed for paving a delineated subregion may be calculated.

Other land area based calculations include an ability to calculate the number of board feet of lumber necessary to construct a deck; the quantity of shingles to cover a roof, or the amount of fertilizer necessary to be applied at a selected concentration to a delineated lawn area.

Thus, the usefulness of aerial image programs can be greatly enhanced for the benefit of contractors, homeowners or others since these added capabilities may eliminate the need for making measurements in the field and for preparing layout drawings.

### DESCRIPTION OF THE DRAWINGS

FIG. 1 is a view of a layout drawing prepared in the conventional way in the course of planning a surface water control installation as described above.

FIG. 2 is a plan view drawing of a typical Google Earth™ aerial image with a defined area of interest delineated and a notation relating to the addition of equally spaced markers at a user selected uniform spacing.

FIG. 2A is a plan view of the area as shown in FIG. 2 with equispaced markers added by the program.

FIG. 3 is a drawing of a screen shot of a window generated by the enhanced aerial program images enabling the selection of the spacing of equispaced markers.

FIG. 4 is a drawing of a screen shot of a window generated the enhanced aerial image program enabling selection of the marker spacing.

FIG. 5 is a drawing of a screenshot of a window generated the enhanced aerial image program enabling selection of display appearance characteristics of the equispaced markers.

FIG. 6 is a drawing of a screenshot of a window generated by the enhanced aerial image program enabling compilation of the total volume of paving material required for a selected depth within a defined area depicting an aerial image.

FIG. 7 is a drawing of a screenshot of a window showing features enabling the selection of a type project by a user and the user inputs necessary to carry out a selected project and the results generated by the enhanced aerial image program.

FIG. 8 is a diagram representing various construction projects able to be facilitated by use of the enhanced aerial image program.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

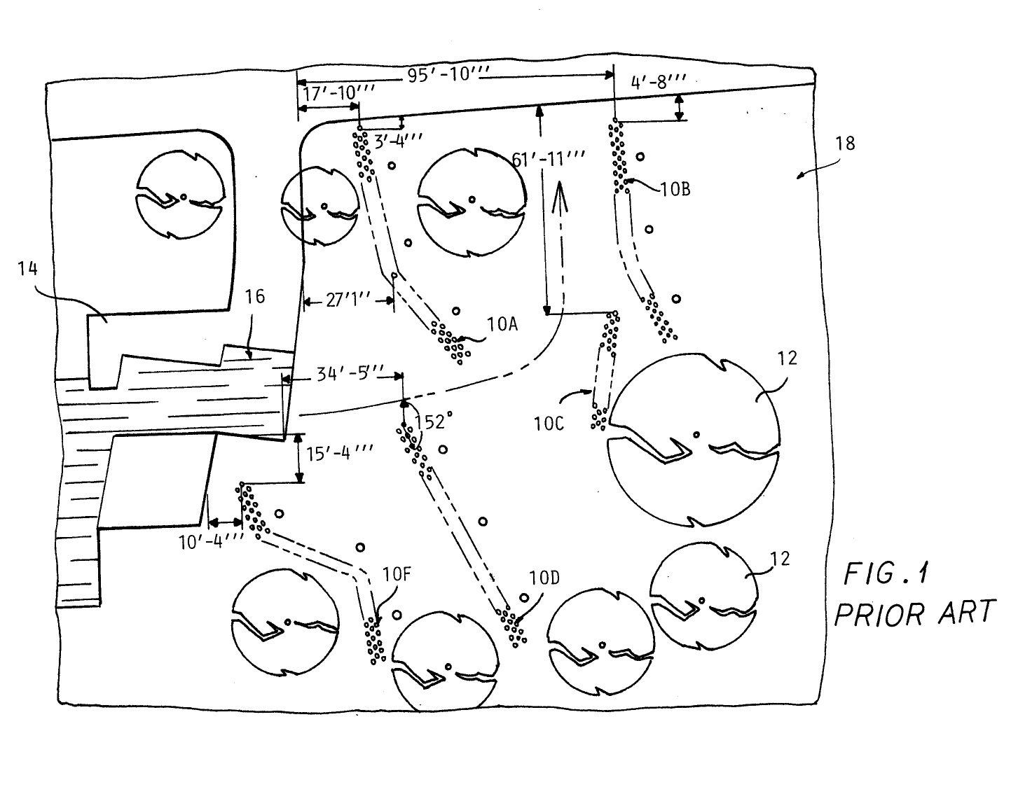

Referring to FIG. 1, a partial layout drawing 18 is depicted, prepared by conventional drafting techniques. Such features as trees 12, pavement areas 14, and buildings 16 are shown. Such a drawing is associated with the installation of several arrays 10A-10F of tubular passive pumps represented by the small circles drawn therein inserted in holes first drilled into the ground, as described in U.S. Pat. No. 8,562,250 issued to the present inventor.

The location and configuration of those arrays is determined by a hydrological analysis and must be laid out prior to their installation. The development of such drawings require substantial time and effort by personnel working on such a project.

Once the layout drawing is prepared, the number of holes and passive tubular pumps must be determined by an inspection of the drawing 10 and a manual count.

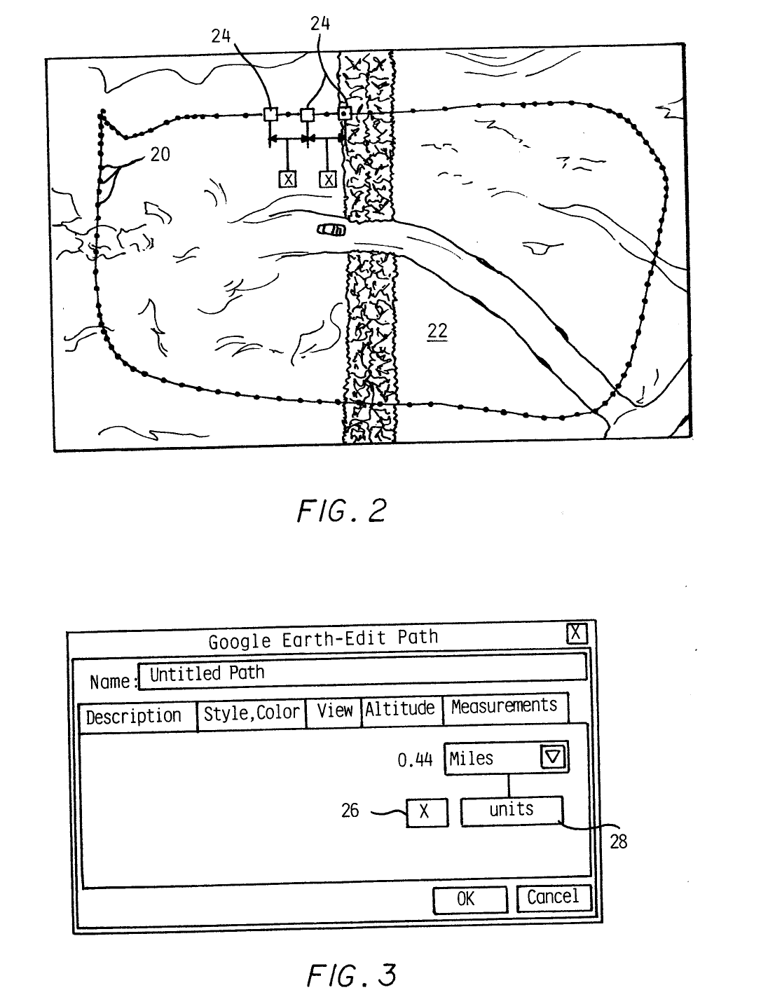

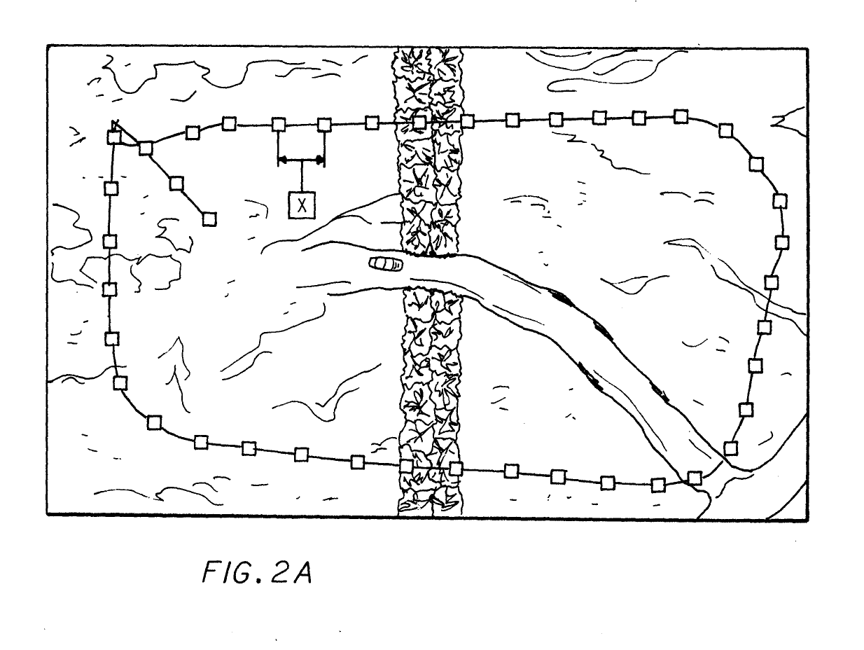

Referring to FIG. 2, a drawing is shown derived from an aerial image of a particular land area obtained from such programs as Google Earth™ or Google Earth Pro™, a virtual geographical program (originally called Earth Viewer 3D) which was acquired by Google Inc. of Mountain View Calif. Imaging is currently offered free to the public, accessed via the internet by means of a computer or other device such as a smart phone, tablet, etc.

The aerial images so obtained show an area of the earth's surface including various salient features, i.e., structures, landscapes, roads, bodies of water, etc.

Google Earth has the capability of allowing users to electronically draw a line circumscribing, and delineating an area 22 of interest within the image, using a series of points 20 marked electronically by the user as indicated. The Google Earth or other aerial imaging programs have an existing capability to generate the length of such a boundary line.

According to the present invention such aerial image programs are enhanced by suitable routinely written software to be able to add to such image a series of a selected electronic markers 24, such as the small squares shown, at a selected spacing X.

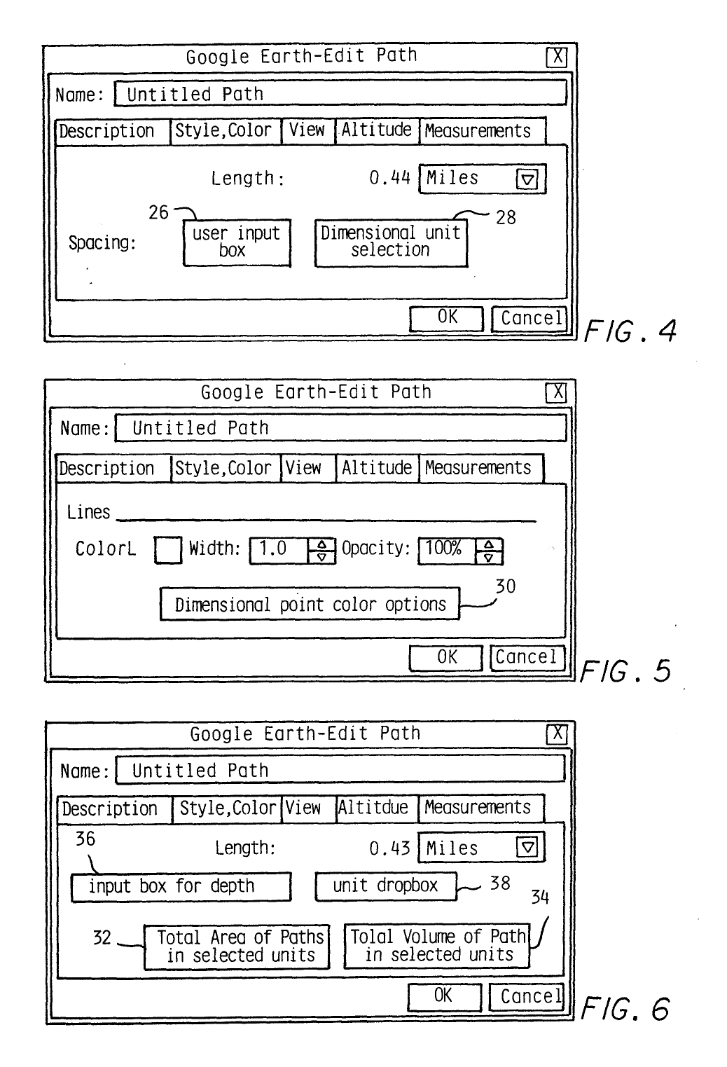

The markers 24 are added precisely spaced apart a user selected distance X which is set by the user using the box 26 and length unit (feet, meters) selected in box 28 as indicated in the program windows in FIGS. 3 and 4, which distance X is selected by the user using the box 26 in units selected in box 28.

FIG. 4 shows an alternate wording of the selection windows.

FIG. 5 shows a program window which allows a user to select a particular color for the markers 24 by use of the box 36 as per conventional practice.

FIG. 6 shows a program window enabling calculation of the total land area within a given boundary line and also the volume of solid paving required with respect to the marked area, seen in boxes 32, 34, with a length unit selection made with box 38.

The user specifies a depth of paving using box 36 when such a paving volume calculation is desired, as for determining the total volume of paving material required by a project.

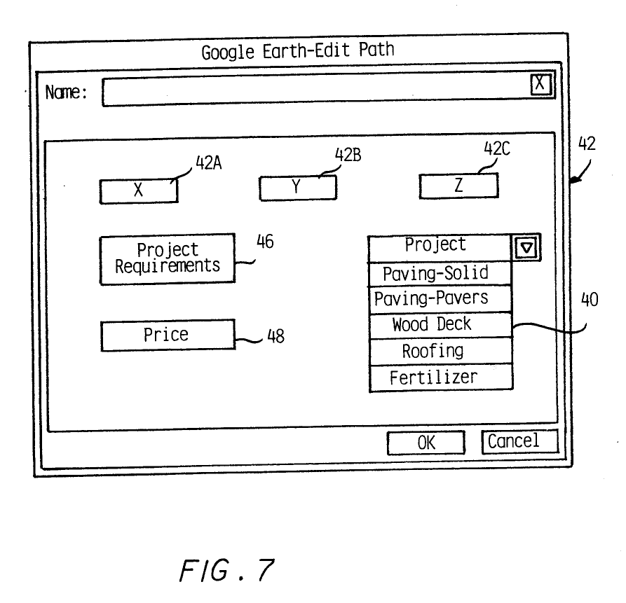

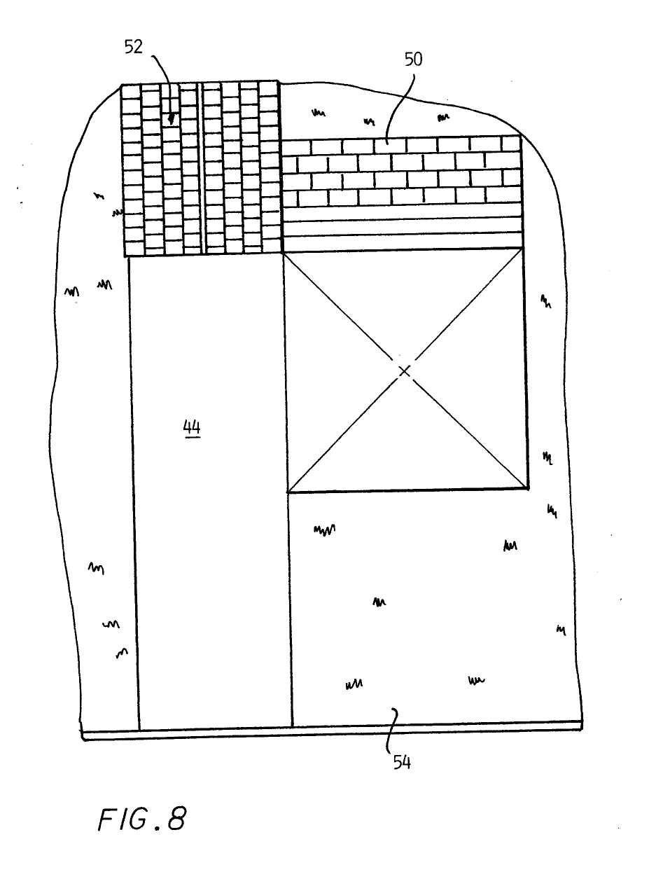

FIGS. 7 and 8 relate to a program modification involving a number of projects set out in a drop down 40 of a program window 42 (FIG. 7).

Three input windows 42A, B, C are used for inputting information by the user, these inputs varying depending on the project selected.

For solid paving, as is done in the driveway area 44 depicted in the diagram of FIG. 8, a depth selection Z can be set as by using box 42. Using that value and a computed area, the total volume of material (i.e. concrete or asphalt) is calculated and displayed in box 46.

For a paver type paving project that is to be done in area 50 in the diagram of FIG. 7, the user inputs the length and width of the pavers in windows 42A, 42B (X and Y), and the number of pavers required will be calculated and that number is displayed in window 48.

If desired, a total cost of materials can be calculated if the user inputs the cost per paver using window 42C (Z).

Accordingly, the utility of Google Earth, Google Earth Pro or similar program is greatly enhanced for the use of contractors, builders, homeowners, etc. in carrying out projects of the type described.

For a wood deck 50, the user inputs the lumber width as in window 42A (X) and the program determines the number of pieces in window 48.

For a roofing project, the user can input the pitch of the roof 52 using window 42C (Z) and the number of shingles (or bundles) is calculated and displayed in window 46.

Finally, the quantity of fertilizer needed forth lawn area 54 can be calculated after the user inputs the rate of application, as total pounds of fertilizer required calculated and displayed in window 46.

1. A method of enhancing an aerial image program comprising adding a program feature capable of selectively calculating the area of user delineated one or more subregions within aerial images produced by said program.

2. The method according to claim 1 further including the additional feature of enabling a user to selectively add markings to the aerial image produced by said program.

3. The method according to claim 1 wherein said additional features include enabling a user to enter information relating to one or more of said user delineated subregions and carries out calculations utilizing said entered data.

4. The method according to claim 3 wherein said one or more subregions comprise one or more areas to be paved with continuous material and said entered data relates to a thickness of said one or more subregions.

5. The method according to claim 3 wherein said one or more subregions comprise one or more areas to be paved with pavers and said data able to be entered relates to the length and width of each paver.

6. The method according to claim 3 wherein said one or more subregions comprise one or more areas to be covered with decking and said data able to be entered comprise the width of decking members.

7. The method according to claim 3 wherein said one or more subregions comprise one or more areas to be roofed with roofing pieces and said data comprises the pitch of said roof.

8. The method according to claim 2 wherein said one or more subregions comprise one or more lawn areas to be fertilized and said data comprises the fertilizer concentration to be applied to said one or more lawn areas.

9. The method according to claim 3 wherein said additional features further enable a drop down list of projects and said data able to be entered by a user varies with the selection of a particular project.

10. The method according to claim 9 wherein said listing of projects includes continuous paving, paving with pavers, decking, roofing and fertilizing lawn of said one or more subregions.
